(19) United States
(12) Patent Application Publication
(10) Pub. No.: US 2008/0216619 A1
(43) Pub. Date: Sep. 11, 2008

(54) Fireman's Rescue Tool

(76) Inventors: Brian D. Brackbill, Saratoga, CA (US); Robert B. Brackbill, Port Angeles, WA (US)

Correspondence Address: QUICKPATENTS, INC., 32861 CALLE PERFECTO, SUITE A, SAN JUAN CAPISTRANO, CA, 92675, US

(21) Appl. No.: 11/682,593

(22) Filed: Mar. 6, 2007

(51) Int. Cl. B25B 28/00

(52) U.S. Cl. 81/463

(57) ABSTRACT

A hand tool for use by a person, such as a firefighter, is disclosed. The hand tool of the present invention comprises a unitary sheet member having a substantially flat top side and bottom side, each mutually connected by at least one peripheral edge. The sheet member comprises a handle portion having a finger grip section and a rear section. The finger grip section is adapted for gripping by the person's fingers, and the rear section is adapted for gripping by the person's palm. The finger grip section includes a first finger guard at least partially therearound for protecting at least two of the person's fingers, depending upon how the person holds the tool. A hook portion has a hook fixed at a hook base proximate to a top section of a neck. The neck is fixed at a bottom section thereof to a top section of the handle portion. A tip of the hook may be formed into a regular screwdriver. Further, pivot notches may be formed in the peripheral edge proximate the tip of the hook. A gas shut-off aperture may be formed into the handle portion, the aperture for fitting around a gas valve and the sheet member rotated around the gas valve for shutting off same.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to hand tools, and more particularly to a fireman's hand tool for aiding in rescuing activities.

### DISCUSSION OF RELATED ART

Rescue workers, and firefighters in particular, sometimes need to aid those trapped in vehicles. Tools such as the so-called “jaws of life” and other pneumatic or hydraulic tools are known for cutting metal, prying doors open and otherwise serving to separate objects in order to rescue those trapped therebetween. Yet for separating smaller items, such as interior trim, plastic, upholstery or headliners, these types of tools are overkill and ineffective and have the capability of cutting into the pressurized airbag inflation cylinder concealed behind some interior trim materials.

To prevent any additional injury to the accident victim or injury to the rescuer, it is necessary to expose the pressurized cylinder that inflates the airbag so as to prevent puncturing same with the Jaws of Life or other cutting equipment used to extricate the accident victim from the vehicle. What is needed is a device that allows rescuers to “peel and peek” so they can identify the locations of the pressurized cylinders prior to cutting or spreading metal. If the pressurized cylinder were breached, it would explode and fragment, possibly severely injuring or even causing death, to both the victims and rescuers alike. A smaller prying tool is necessary in order to pull the lining away from the vehicle frame proximate such pressurized cylinders. In a locked vehicle, having a tool that can both break glass and pry apart interior materials is critical. Further, such a tool needs to be readily available without the need for power or a heavy equipment belt.

For example, a conventional hammer is not effective in such situations due to its size and inability to easily tear through roofing materials or upholstery. Further, a hammer does not protect the hand of the user in any way from shards of glass or other sharp debris that may be in the hand's travel path when swinging such a device.

One firefighter's tool, marketed under the name “Ardis Tool,” includes a hook portion pivotally fixed to a handle portion. Such a tool, while more effective than a conventional hammer, does not provide finger or hand protection to the user. Further, such a device is made of several parts that must be assembled, and as such is considerably more expensive to manufacture than a tool stamped or cut out of a single piece of sheet metal stock.

Therefore, there is a need for an inexpensive firefighter's tool suitable for use in breaking glass, and tearing and prying upholstery, roofing fabrics and other types of vehicle trim away from a vehicles frame. Such a needed device would be made from a single piece of metal stock, well-balanced when handling, durable, and easy to stow in a turn-out pocket, or the like. The present invention accomplishes these objectives.

### SUMMARY OF THE INVENTION

The present device is a hand tool for use by a person, such as a firefighters Such a tool can be used to pry upholstery away from a vehicle frame and aid in the breaking and removal of a broken windshield or the like.

Further, the tool may be quickly and easily stored in a firefighter's Personal Protective Equipment (PPE), commonly referred to as a firefighter's “turnouts,” which have pockets in the jacket and pants portions that readily accommodate the present device for easy access thereto.

The hand tool of the present invention comprises a unitary sheet member having a substantially flat top side and bottom side, each mutually connected by at least one peripheral edge. Preferably the sheet member is made from a metallic sheet material which can be stamped or cut with, for example, a laser cutting process.

The sheet member comprises a handle portion having a finger grip section and a rear section. The finger grip section is adapted for gripping by the person's fingers, and the rear section is adapted for gripping by the person's palm. Preferably, the handle portion further includes a flared base section, which further aids in grasping of the tool by the person.

The finger grip section includes a first finger guard at least partially therearound for protecting at least two of the person's fingers, depending upon how the person holds the tool.

A hook portion has a hook fixed at a hook base proximate to a top section of a neck. The neck is fixed at a bottom section thereof to a top section of the handle portion. A tip of the hook may be formed into a regular screwdriver. Further, pivot notches may be formed in the peripheral edge proximate the tip of the hook. Such pivot notches, when the hook is forced between, for example, two elements of a vehicle, allow the top peripheral edge to grab one element for pivoting the hook and separating the two elements.

A gas shut-off aperture may be formed into the handle portion, the aperture for fitting around a gas valve and the sheet member rotated around the gas valve for shutting off same.

Preferably, and not with the intention of limiting the invention to specific dimensions, a height dimension of the hand tool is between eight and ten inches. The preferred hook length dimension is between four and five inches. The depth dimension of the sheet member is preferably between ¼ and ⅛ of an inch, and more specifically 3/16 of an inch thick.

Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a left side elevational view of the invention;

FIG. 2 is a front elevational view of the invention;

FIG. 3 is a perspective view of the invention, as held in one manner by a person;

FIG. 4 is a perspective view of the invention, as held in an alternate manner by the person; and

FIG. 5 is a perspective view of the invention, illustrating an embodiment thereof having a secondary finger guard.

### DETAILED DESCRIPTION OF THE PREFERRED EMBODIMENT

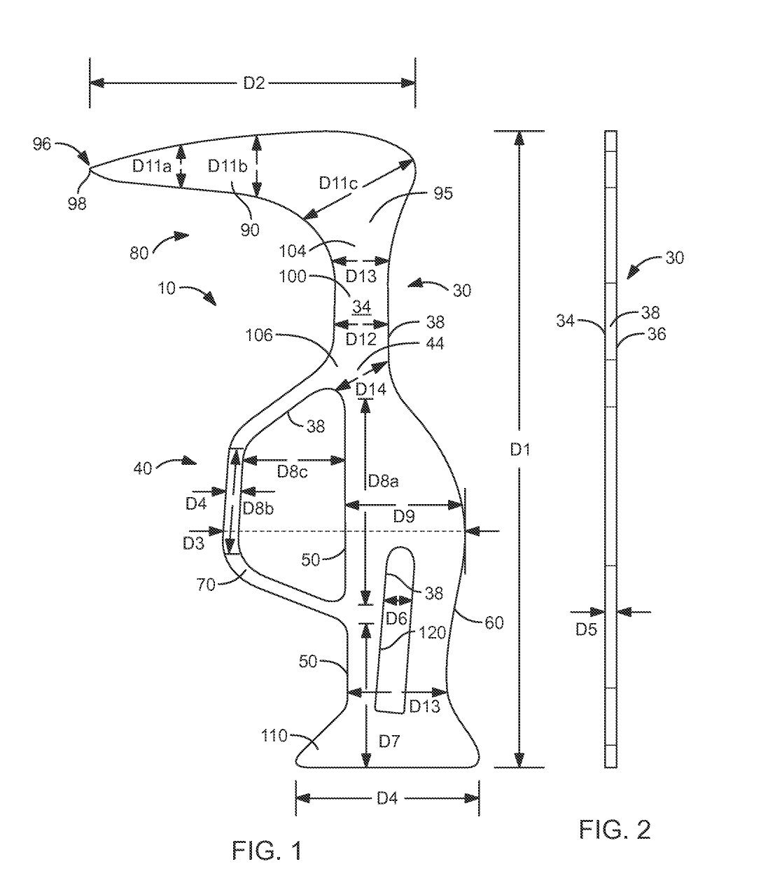

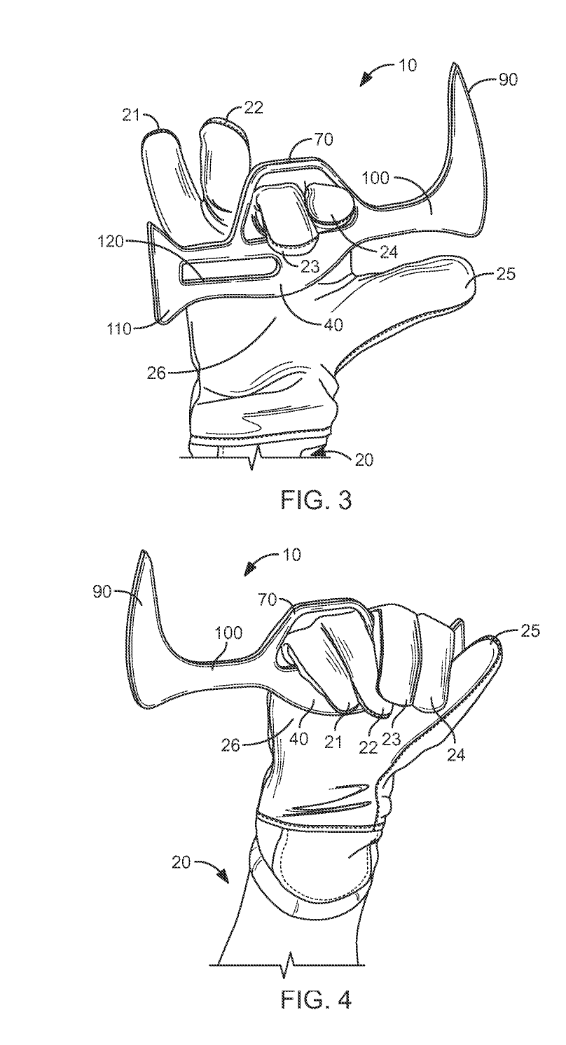

The present invention, illustrated in FIGS. 1 and 3, is directed towards a hand tool 10 for use by a person 20, such as a firefighters Such a tool can be used to pry upholstery away from a vehicle frame (not shown), aid in the breaking and removal of a windshield (not shown), or the like. Further, the tool 10 may be quickly and easily stored and retrieved from the firefighter's PPE turnout pockets, located in the jacket or pants section thereof.

The hand tool 10 of the present invention comprises a unitary sheet member 30 having a substantially flat top side 34 and bottom side 36, each mutually connected by at least one peripheral edge 38. Preferably the sheet member 30 is made from a metallic sheet material which can be stamped or cut with, for example, a laser cutting process. Alternately, the tool 10 may be cast from iron or other molten metals or alloys.

The sheet member 30 comprises a handle portion 40 having a finger grip section 50 and a rear section 60. The finger grip section 50 is adapted for gripping by the person's fingers 21-24, and the rear section 60 is adapted for gripping by the person's palm 26. Preferably, the handle portion 40 further includes a flared base section 110 (FIG. 1), which further aids in grasping of the tool 10 by the person 20.

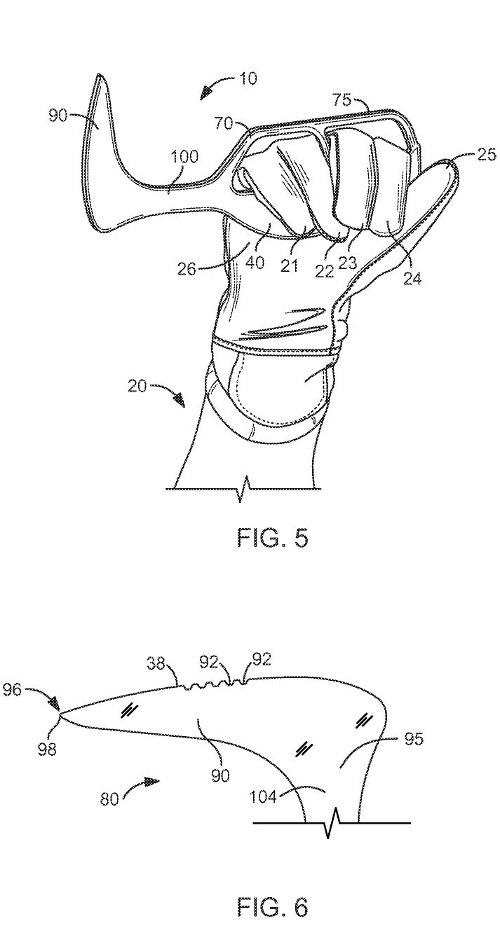

The finger grip section 50 includes a first finger guard 70 at least partially therearound for protecting at least two of the person's fingers 21-22 (FIG. 4) or 23-24 (FIG. 3), depending upon how the person 20 holds the tool 10. The handle portion 40 may further include, in one embodiment, a secondary finger guard 75 (FIG. 5) fixed thereto for protecting any of the person's fingers 21-24 not protected by the first finger guard 70.

A hook portion 80 has a hook 90 fixed at a hook base 94 proximate to a top section 104 of a neck 100. The neck 100 is fixed at a bottom section 106 thereof to a top section 44 of the handle portion 40. A tip 96 of the hook 90 may be formed into a regular screwdriver 98. Further, pivot notches 92 may be formed in the peripheral edge 38 proximate the tip 96 of the hook 90. Such pivot notches 92, when the hook 90 is forced between, for example, two elements of a vehicle (not shown), allow the top peripheral edge 38 to grab one element for pivoting the hook 90 and separating the two elements. Without the notches 92, the hook 90 may just slip against the elements without gaining a foothold.

A gas shut-off aperture 120 may be formed into the handle portion 40 (FIG. 1), the aperture 120 for fitting around a gas valve (not shown) and the sheet member 30 rotated around the gas valve for shutting off same. Typically the person 20 would gasp the neck 100 to gain enough leverage with the length of the sheet member 30 in order to turn such a gas valve.

Preferably, and not with the intention of limiting the invention to specific dimensions, a height dimension D₁ of the hand tool 10 (FIG. 1) is between eight and ten inches. The preferred hook length dimension D₂ is between four and five inches. The depth dimension D₁₅ (FIG. 2) of the sheet member 30 is preferably between ¼ and ⅛ of an inch, and more specifically substantially 3/16 of an inch thick. With respect to the other dimensions shown in FIG. 1, the following table presents preferred dimensions:

| Dim | Inches |
|---|---|
| D₁ | 9″ |
| D₂ | 4.5″ |
| D₃ | 3 5/16 |
| D₄ | 2 7/16″ |
| D₅ | 3/16″ |
| D₆ | ⅜″ (and 2⅝″ long) |
| D₇ | 2¼″ |
| D₈ₐ | 2⅝″ |
| D_{8b} | 1¾″ |
| D_{8c} | 1½″ |
| D₉ | 1⅜″ |
| D₁₁ₐ | ⅝″ |
| D_{11b} | 1″ |
| D_{11c} | 1⅝″ |
| D₁₂ | ⅝″ |
| D₁₃ | 1¼″ |
| D₁₄ | ⅝″ |
| D₁₅ | 3/16″ |

In use, the person 20 may grasp the tool 10 as shown in either FIG. 3 or 4 to break glass, such as in vehicle windows and windshields, pry upholstery away from the vehicle frame to expose the pressurized airbag inflation cyclinder, shut-off gas valves, and like activities during fire and rescue operations. The weight of the tool 10 is balanced substantially around a center point thereof, making the tool 10 comfortable and effective to use. Further, the shape of the handle portion 40 and the peripheral edge 38 is such that it conforms to the person's hand when gasped as shown in either FIG. 3 or FIG. 4.

While a particular form of the invention has been illustrated and described, it will be apparent that various modifications can be made without departing from the spirit and scope of the invention. For example, the exact dimensions and shape of the tool 10 may vary from those shown in the drawings and listed in this detailed description. Accordingly, it is not intended that the invention be limited, except as by the appended claims.

1. A hand tool for use by a person, the hand tool comprising a unitary sheet member having substantially flat top and bottom sides connected by at least one peripheral edge, the sheet member including:
a handle portion having a finger grip section and a rear section, the finger grip section adapted for gripping by the person's fingers, the rear section adapted for gripping by the person's palm, the finger grip section including a first finger guard therearound for protecting at least two of the person's fingers;
a hook portion having a hook fixed at a hook base proximate to a top section of a neck that is fixed at a bottom section thereof to a top section of the handle portion;
an elongated gas shut-off aperture formed in the handle portion;
wherein a tip of the hook forms a regular screwdriver; and,
wherein a plurality of pivot notches are formed into the peripheral edge of the sheet member proximate the tip of the hook.

2. The hand tool of claim 1 wherein the handle portion further includes a flared base section.

3. The hand tool of claim 1 wherein the handle portion further includes a secondary finger guard fixed thereto for protecting any of the person's fingers not protected by the first finger guard.

4. (canceled)

5. The hand tool of claim 1 wherein a height dimension of the hand tool is between eight and ten inches.

6. The hand tool of claim 1 wherein a hook length dimension is between four and five inches.

7. (canceled)

8. The hand tool of claim 1 wherein a depth dimension of the sheet member is approximately 3/16 of an inch.

9. The hand tool of claim 1 wherein the rear section of the handle portion is curved to conform to the shape of the person's palm and thumb.

10. (canceled)
